(19) United States
(12) Patent Application Publication
(10) Pub. No.: US 2024/0193556 A1
(43) Pub. Date: Jun. 13, 2024

(54) SYSTEMS AND METHODS FOR AUTOMATED REMEDIATION OF CHECK DATA ERRORS

(71) Applicant: JPMORGAN CHASE BANK, N.A., New York, NY (US)

(72) Inventor: Jerome JOSEPH, Lewis Center, OH (US)

(21) Appl. No.: 18/064,579

(22) Filed: Dec. 12, 2022

(51) Int. Cl. G06Q 20/04; G06N 20/00

(52) U.S. Cl. CPC G06Q 20/042; G06N 20/00

(57) ABSTRACT

Systems and methods for automated remediation of check data errors are disclosed. In one embodiment, a method for automated remediation of check data errors may include: (1) receiving, by a routing computer program, a check image from an acquisition channel; (2) extracting, by an extraction computer program, transaction information from the check image; (3) determining, by the routing computer program, that there is an error in the transaction information; (4) identifying, by a remediation computer program, a correction for the error a confidence score in the correction using a trained machine learning correction engine; and (5) correcting, by the remediation computer program, the error with the correction in response to the confidence score being above a confidence score threshold.

### BACKGROUND OF THE INVENTION

### 1. Field of the Invention

Embodiments generally relate to systems and methods for automated remediation of check data errors.

### 2. Description of the Related Art

Large organizations use many computer products. There are no proactive ways to identify and/or monitor the inherent cyber-tech risks of existing products before they are used. Due to a lack of product-based risk ranking methodology, currently cyber-risk considerations often starts late in the Software Development Life Cycle (SDLC) which brings resource overhead and often results in unwanted cyber-risk exposures.

### SUMMARY OF THE INVENTION

Systems and methods for automated remediation of check data errors are disclosed. In one embodiment, a method for automated remediation of check data errors may include: (1) receiving, by a routing computer program, a check image from an acquisition channel; (2) extracting, by an extraction computer program, transaction information from the check image; (3) determining, by the routing computer program, that there is an error in the transaction information; (4) identifying, by a remediation computer program, a correction for the error a confidence score in the correction using a trained machine learning correction engine; and (5) correcting, by the remediation computer program, the error with the correction in response to the confidence score being above a confidence score threshold.

In one embodiment, the transaction information may include an account number, a routing number, an auxiliary on-us (auxonus) field, an external processing code (EPC), a process control, a check number, a payee name, and a payer name.

In one embodiment, the error may include an optical character recognition error, an image error, etc.

In one embodiment, the trained machine learning correction engine may be trained with historical data to identify the correction from a similar transaction information pattern in historical transaction information.

In one embodiment, the confidence score threshold may be 100%, 90%, etc.

In one embodiment, the confidence score threshold may be dynamic based on a field in the transaction information being corrected.

According to another embodiment, a system may include a check acquisition module that acquire a check image from an acquisition channel; a data extraction module that extracts transaction information from the check image; routing computer program that identifies an error in the transaction information; and a remediation computer program that identifies a correction for the error a confidence score in the correction using a trained machine learning correction engine and corrects the error with the correction in response to the confidence score being above a confidence score threshold.

In one embodiment, the transaction information may include an account number, a routing number, an auxiliary on-us (auxonus) field, an external processing code (EPC), a process control, a check number, a payee name, and a payer name.

In one embodiment, the error may include an optical character recognition error, an image error, etc.

In one embodiment, the trained machine learning correction engine may be trained with historical data to identify the correction from a similar transaction information pattern in historical transaction information.

In one embodiment, the confidence score threshold may be 100%, 90%, etc.

In one embodiment, the confidence score threshold may be dynamic based on a field in the transaction information being corrected.

According to another embodiment, a non-transitory computer readable storage medium may include instructions stored thereon, which when read and executed by one or more computer processors, cause the one or more computer processors to perform steps comprising: receiving a check image from an acquisition channel; extracting transaction information from the check image; determining that there is an error in the transaction information; identifying a correction for the error a confidence score in the correction using a trained machine learning correction engine; and correcting the error with the correction in response to the confidence score being above a confidence score threshold.

In one embodiment, the transaction information may include an account number, a routing number, an auxiliary on-us (auxonus) field, an external processing code (EPC), a process control, a check number, a payee name, and a payer name.

In one embodiment, the error may include an optical character recognition error, an image error, etc.

In one embodiment, the trained machine learning correction engine may be trained with historical data to identify the correction from a similar transaction information pattern in historical transaction information.

In one embodiment, the confidence score threshold may be 100%, 90%, etc.

In one embodiment, the confidence score threshold may be dynamic based on a field in the transaction information being corrected.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for automated remediation of check data errors according to an embodiment.

FIG. 2 depicts a method for automated remediation of check data errors according to one embodiment.

FIG. 3 depicts an exemplary computing system for implementing aspects of the present disclosure.

### DETAILED DESCRIPTION OF PREFERRED EMBODIMENTS

Embodiments are directed to systems and methods for automated remediation of check data errors.

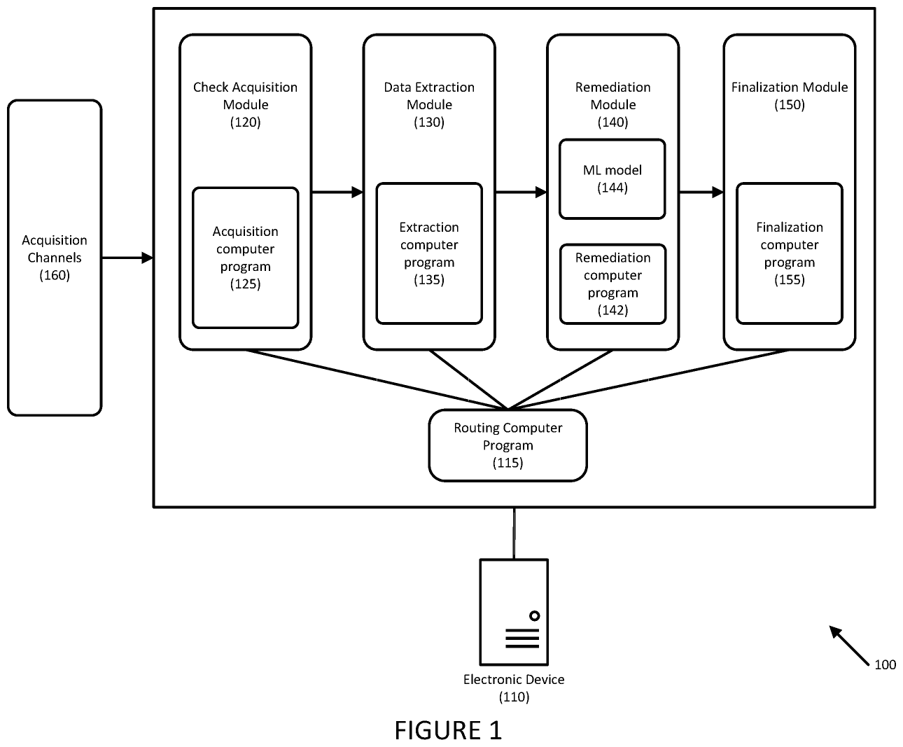

Referring to FIG. 1, a system for automated remediation of check data errors is disclosed according to an embodiment. System 100 may include electronic device 110, which may be one or more suitable electronic devices, such as servers (e.g., cloud based and/or physical), computers (e.g., workstation, desktop, notebook, laptop, tablet, etc.), smart devices (e.g., smartphones, smartwatches, etc.) Internet of Things (IOT) appliances, etc. Electronic device 110 may execute one or more modules, such as check acquisition module 120, data extraction module 130, remediation module 140, and finalization module 150. Each module 120, 130, 140, and 150 may execute computer programs, such as acquisition computer program 125, extraction computer program 135, remediation computer program 142, and finalization computer program 155.

Acquisition computer program 125 may receive check information, such as check images, from acquisition channels 160, such as mobile devices, automated teller machines, lockboxes, tellers, external financial institutions, merchants, etc. It may group the check information into batches.

Extraction computer program 135 may extract check data from the acquired check information. For example, extraction computer program 135 may use optical character recognition (OCR) to identify characters in fields (e.g., an account number, a routing number, an auxiliary on-us (auxonus) field, an external processing code (EPC), a process control, a check number, a payee name, a payer name printed on the check, etc.

Remediation computer program 142 may receive check data when there is an error (e.g., OCR or image issue) with a check and may apply one or more machine learning (ML) models 144 to predict an accurate correction to the error.

ML models 144 may comprise recursive neural networks that attempt to match the historical check attributes, such as account number and routing number, payee name, check number, with transaction data and generate a confidence score in a predicted correct. Each check attribute may have a weighting. In one embodiment, a confidence score threshold of 100% may be used. In another embodiment, a confidence score threshold of 90% may be used. Thus, if the confidence score is not at or above the confidence score threshold, the check may be sent for human review.

Other confidence score thresholds may be used as is necessary and/or desired. In one embodiment, the confidence score threshold may be dynamic and may be based on the field that is being corrected. For example, a check number may have a different confidence score threshold than a routing or account number.

Finalization computer program 155 may receive check data for check with and without corrections, and may perform further processing (e.g., deposit funds to the appropriate account).

Routing computer program 115 may manage the flow of a check through modules 120, 130, 140, and 150. In one embodiment, routing computer program 115 may determine if there are any errors in the check data, and may route the check data to remediation module as necessary.

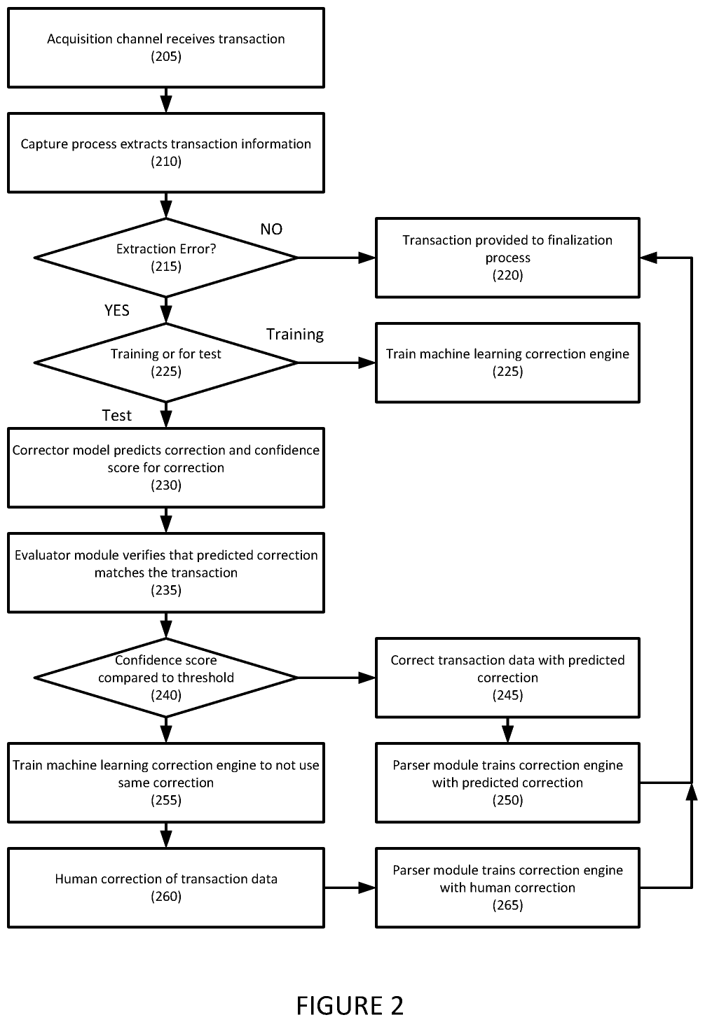

Referring to FIG. 2, a method for automated remediation of check data errors is disclosed according to an embodiment.

In step 205, an acquisition channel may receive a transaction, such as check deposit. For example, a check deposit may be received from mobile devices, automated teller machines, lockboxes, tellers, external financial institutions, merchants, etc.

In one embodiment, a batch process may be used to acquire a large volume of transactions after they are vetted for validity.

In step 210, a capture process may transform the transactions into credits and debits based. The capture process may further invoke a data extraction process to read transaction information, such as an account number, a routing number, an auxonus field, an EPC, a process control, a check number, a payee name, a payer name printed on the check, etc.

In step 215, a routing computer program may determine if there are any errors in extracting the data. For example, the image quality may lead to optical character recognition errors.

In one embodiment, errors may be identified by comparing the extracted data to transaction data. In another embodiment, the data extraction module may identify an extraction error, or a data extraction check may indicate a lack of confidence in the extraction from, for example, the OCR.

If there are no errors, in step 220, the routing computer program may route the check data to a finalization module.

If there is an error, in step 225, a data parser module may receive the extracted information and may perform a differentiation conditional test to determine whether the extracted information is for test or training. If it is for training, in step 225, the data parser module may train a machine learning correction engine with the extracted information. In one embodiment, the data parser module may train a machine learning model with the extracted information (e.g., the information from the machine learning correction engine) to predict the correction.

If the information is for test, in step 230, the data parser module may pass the extracted information to a corrector module to use a trained machine learning correction engine to predict a correction and a confidence score in the correction based on one or more of the payer name, payee name, account number, routing number, auxonus, EPC, process control, etc. Any of the fields in the transaction data may be incorrect, thus, the fields may be compared to reference/historical information for similar patterns. From these patterns, the trained machine learning correction engine may return a predicted correction and a confidence score in the correction.

In step 235, the predicted correction and confidence score may be presented to an evaluator module with the predicted correction for the transaction information. The evaluator module may verify that the data matches with the information presented on the transaction.

In step 240, the confidence score may be evaluated against a threshold, such as 100%. If the confidence score meets this requirement, in step 245, the transaction may be corrected with the predicted correction.

In step 250, the parser module may train the correction engine with predicted correction, and in step 220, the corrected transaction may be provided to a finalization process.

If the probable score is not at the threshold, in step 255, the transaction may be recursively looped back to the parser module to train the machine learning correction engine to not apply the correction pattern to any other similar transactions.

In step 260 the incorrect transaction may be provided to a remediation process for human verification of the check image, and correction of the data.

In step 265, the human and corrected data is then passed to the parser module, which may then train the machine learning correction engine. The corrected transaction may then be passed to the finalization process in step 220.

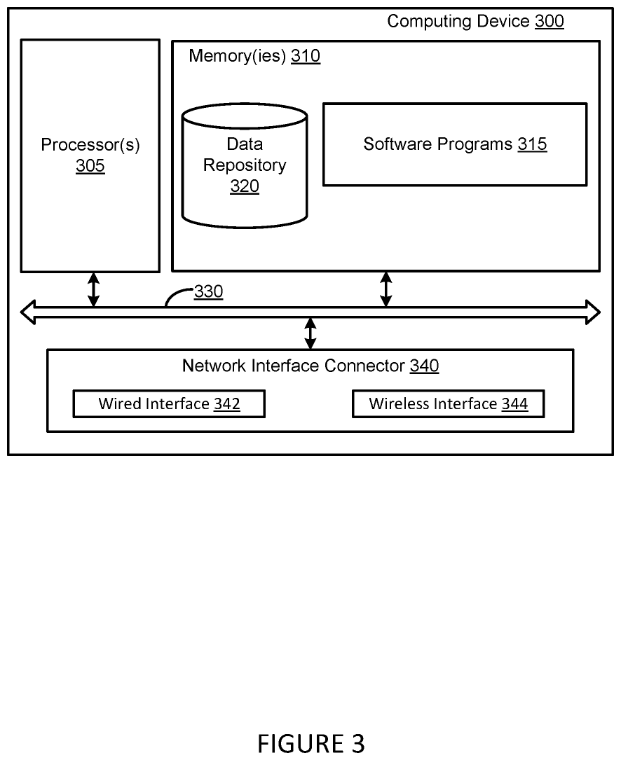

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

The disclosures of U.S. Provisional Patent Application Ser. Nos. 63/126,935 and 63/138,951, U.S. patent application Ser. No. 17/538,763, and U.S. patent application Ser. No. 17/664,579 are hereby incorporated, by reference, in their entireties.

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for automated remediation of check errors, comprising:
receiving, by a routing computer program, a check image from an acquisition channel;
extracting, by an extraction computer program, transaction information from the check image;
determining, by the routing computer program, that there is an error in the transaction information;
identifying, by a remediation computer program, a correction for the error a confidence score in the correction using a trained machine learning correction engine; and
correcting, by the remediation computer program, the error with the correction in response to the confidence score being above a confidence score threshold.

2. The method of claim 1, wherein the transaction information comprises an account number, a routing number, an auxiliary on-us (auxonus) field, an external processing code (EPC), a process control, a check number, a payee name, and a payer name.

3. The method of claim 1, wherein the error comprises an optical character recognition error.

4. The method of claim 1, wherein the error comprises an image error.

5. The method of claim 1, wherein the trained machine learning correction engine is trained with historical data to identify the correction from a similar transaction information pattern in historical transaction information.

6. The method of claim 1, wherein the confidence score threshold is 100%.

7. The method of claim 1, wherein the confidence score threshold is dynamic based on a field in the transaction information being corrected.

8. A system, comprising:
a check acquisition module that acquire a check image from an acquisition channel;
a data extraction module that extracts transaction information from the check image;
routing computer program that identifies an error in the transaction information; and
a remediation computer program that identifies a correction for the error a confidence score in the correction using a trained machine learning correction engine and corrects the error with the correction in response to the confidence score being above a confidence score threshold.

9. The system of claim 8, wherein the transaction information comprises an account number, a routing number, an auxiliary on-us (auxonus) field, an external processing code (EPC), a process control, a check number, a payee name, and a payer name.

10. The system of claim 8, wherein the error comprises an optical character recognition error.

11. The system of claim 8, wherein the error comprises an image error.

12. The system of claim 8, wherein the trained machine learning correction engine is trained with historical data to identify the correction from a similar transaction information pattern in historical transaction information.

13. The system of claim 8, wherein the confidence score threshold is 100%.

14. The system of claim 8, wherein the confidence score threshold is dynamic based on a field in the transaction information being corrected.

15. A non-transitory computer readable storage medium, including instructions stored thereon, which when read and executed by one or more computer processors, cause the one or more computer processors to perform steps comprising:
receiving a check image from an acquisition channel;
extracting transaction information from the check image;
determining that there is an error in the transaction information;
identifying a correction for the error a confidence score in the correction using a trained machine learning correction engine; and
correcting the error with the correction in response to the confidence score being above a confidence score threshold.

16. The non-transitory computer readable storage medium of claim 15, wherein the transaction information comprises an account number, a routing number, an auxiliary on-us (auxonus) field, an external processing code (EPC), a process control, a check number, a payee name, and a payer name.

17. The non-transitory computer readable storage medium of claim 15, wherein the error comprises an optical character recognition error.

18. The non-transitory computer readable storage medium of claim 15, wherein the error comprises an image error.

19. The non-transitory computer readable storage medium of claim 15, wherein the trained machine learning correction engine is trained with historical data to identify the correction from a similar transaction information pattern in historical transaction information.

20. The non-transitory computer readable storage medium of claim 15, wherein the confidence score threshold is dynamic based on a field in the transaction information being corrected.
